(19) United States
(12) Patent Application Publication
(10) Pub. No.: US 2018/0350127 A1
(43) Pub. Date: Dec. 6, 2018

(54) METHODS AND APPARATUS FOR DYNAMIC, EXPRESSIVE ANIMATION BASED UPON SPECIFIC ENVIRONMENTS

(71) Applicant: Yearbooker, Inc., New York, NY (US)

(72) Inventors: Robert Davidson, New York, NY (US); Fanny Chung Davidson, New York, NY (US)

(21) Appl. No.: 16/102,219

(22) Filed: Aug. 13, 2018

Related U.S. Application Data
(63) Continuation-in-part of application No. 15/484,954, filed on Apr. 11, 2017.
Application No. 15/484,954 is a continuation-in-part of application No. 14/535,270, filed on Nov. 6, 2014, now Pat. No. 9,030,496.
(60) Provisional application No. 62/544,785, filed on Aug. 12, 2017.
(60) Provisional application No. 62/320,663, filed on Apr. 11, 2016.
(60) Provisional application No. 62/012,386, filed on Jun. 15, 2014.
(60) Provisional application No. 61/971,493, filed on Mar. 27, 2014.
(60) Provisional application No. 61/901,042, filed on Nov. 7, 2013.

(51) Int. Cl. G06T 13/80; H04L 12/58; G01W 1/06

(52) U.S. Cl. CPC G06T 13/80; G01W 1/06; H04L 51/10; H04L 51/04

(57) ABSTRACT

The present disclosure provides for image processing apparatus for generating dynamic image data and corresponding Spatial Coordinates based upon one or more environmental conditions registered with a Sender Unit and a recipient Unit. The dynamic imagery input will generally be related to the environmental condition and also correspond with selected Spatial Coordinates. The dynamic imagery is based upon an environmental condition experienced by at least one of a generating device and a displaying device.

### CROSS REFERENCE TO RELATED APPLICATIONS

The present application claims the benefit of U.S. Provisional Patent Application Ser. No. 62/544,785 entitled Methods and Apparatus for Dynamic, Expressive Animation Based Upon Specific Environments, filed Aug. 12, 2017; and claims priority as a Continuation in Part application to U.S. patent application Ser. No. 15/484,954, entitled Methods and Apparatus for Dynamic Image Entries filed Apr. 11, 2017, which in turn claims the benefit of U.S. Provisional Patent Application Ser. No. 62/320,663 entitled Methods and Apparatus for Interactive Memory Book with Motion Based Annotations filed Apr. 11, 2016. The U.S. patent application Ser. No. 15/484,954 claims priority as a Continuation in Part application to U.S. patent application Ser. No. 14/535,270 entitled Methods for and Apparatus for Interactive School Yearbook now U.S. Pat. No. 9,030,496 issued May 12, 2015; which in turn claims the benefit of U.S. Provisional Patent Application Ser. No. 62/012,386 entitled Methods for and Apparatus for Interactive School Yearbook filed Jun. 15, 2014; and also claims the benefit of U.S. Provisional Patent Application Ser. No. 61/971,493 entitled Methods for and Apparatus for Interactive School Yearbook filed Mar. 27, 2014; and also claims the benefit of U.S. Provisional Patent Application Ser. No. 61/901,042 entitled Methods for and Apparatus for Interactive School Yearbook filed Nov. 7, 2013.

### FIELD OF THE DISCLOSURE

The present disclosure relates to image processing apparatus for generating dynamic, animations based upon the environment and being placed at corresponding Spatial Coordinates and based upon media input from a user which becomes animated based upon environmental conditions of one or both of the place input and the place of display.

### BACKGROUND OF THE DISCLOSURE

Digital communications continue to rise in volume and frequency of use and have become the preferred modality of communication for many millions of people. However, to a large extent the digital communications between two users are limited to static thoughts dictated by a user.

### SUMMARY OF THE DISCLOSURE

Accordingly, the present disclosure provides for image processing apparatus for generating dynamic image data based upon one or both of: conditions of an area proximate to a sender, and conditions proximate to a receiver. In some embodiments, the present invention includes one or both of the sender and the user associating corresponding Spatial Coordinates for locating the dynamic imagery based upon physical environmental conditions experienced by one or both of a local device used to generate the dynamic imagery and a device used to display the imagery.

Accordingly, the dynamic media input is generally related to the image data corresponding with selected Spatial Coordinates. Dynamic media input becomes animated based upon physical conditions registered by a device upon which the dynamic media is generated and or on a device upon which it is displayed may include, for example, an animation that changes appearance based upon environmental conditions, including one or more of: motion, heat, cold, windy, wet, humidity or other physical condition such as motion, acceleration, vector speed in a certain direction, vibrations, dancing, shaking, camera and microphone input, biometric information including for example, fingerprint and/or face identification can all be registered by the device controlling display of the imagery. The camera recognizes such items as a menu, or that there is food or a restaurant nearby and responds accordingly. The dynamic animation or sticker reacts in an array of different actions such as sniffing the air or licking its lips, taking out a knife and fork. The camera will also remember if the user has ordered previous items from the menu. The animation can recognize and respond to real objects and environmental information, rather than just being placed on real objects.

This system uses Artificial Intelligence to identify objects and the surrounding environment and responds in the relevant manner, This is different from the applications available such as “SnapChat®” where if you perform a certain function the animation switches between two different animations, thus making a defined outcome based upon a perceived function. In some embodiments, tracking movement of a visual anchor may change perspective. In the present application the camera remembers and responds to the user and the particular environment making it a personally enhanced experience.

In some embodiments, a static image may be a communication sent from a first senders unit to a receiving unit that is being used to play a game from an App, such as an augmented reality game, and dynamic media may be overlaid on a static screen. Also in this enhanced application the server can be the sender not just the receiver of information.

Physical conditions experienced by the device upon which the imagery is displayed may include an environmental condition the device is exposed to. Environmental conditions that drive interactive movement and visualization of overlaid imagery may be triggered by, or otherwise based upon hardware sensors and may therefore include, for example: a motion coprocessor, accelerometer, gyroscopes, barometer, thermometer, CCD camera, light sensor, a moisture sensor, a compass, GPS, altitude calculations, micro location (beacons), ambient light sensors, proximity sensors, biometric sensors (such as, fingerprint and facial recognition), voice activation, touch-gestures and duration on screen.

According to some embodiments, a Photo Memory book enabling apparatus includes a digital server accessible with a network access device via a digital communications network and executable software stored on the server and executable on demand. The software is operative with the server to cause the apparatus to transmit over the digital communications network a Photo Memory book interface comprising a plurality of images. The server will receive a designation of a Signing User and one or more dynamic images, which may be based upon an environmental condition. The server will also receive a media input and a Cartesian Coordinate associated with the media input.

A system of one or more computers can be configured to perform particular operations or actions by virtue of having software, firmware, hardware, or a combination of them installed on the system that in operation causes the system to perform specific actions, such as receive sensor input, execute method steps based upon the sensor input. One or more computer programs can be configured to perform particular operations or actions by virtue of including instructions that, when executed by data processing apparatus, cause the apparatus to perform the actions.

### BRIEF DESCRIPTION OF THE DRAWINGS

The accompanying drawings are incorporated in and constitute a part of this specification, illustrate several embodiments of the disclosure and, together with the description, serve to explain the principles of the disclosure:

FIG. 1A illustrates block diagrams of exemplary user interfaces including functionalities that may be used to implement some embodiments of the present disclosure.

FIG. 1B illustrates block diagrams of exemplary user interfaces including functionalities that may be used to implement some embodiments of the present disclosure.

FIG. 1C illustrates block diagrams of exemplary user interfaces including functionalities that may be used to implement some embodiments of the present disclosure.

FIG. 1D illustrates block diagrams of exemplary user interfaces including functionalities that may be used to implement some embodiments of the present disclosure.

FIG. 2 illustrates a web interface viewed by an administrator, the web interface including functionalities that may be used to implement some embodiments of the present disclosure.

FIG. 3 illustrates a web interface viewed by a main contact, the web interface includes functionalities that may be used to implement some embodiments of the present disclosure.

FIG. 4A illustrates a web interface viewed by the main contact, the web interface includes functionalities that may be used to implement some embodiments of the present disclosure.

FIG. 4B illustrates a web interface viewed by the main contact, the web interface includes functionalities that may be used to implement some embodiments of the present disclosure.

FIG. 5A illustrates an application user interface viewed by a user, the application user interface includes functionalities that may be used to implement some embodiments of the present disclosure.

FIG. 5B illustrates an application user interface viewed by a user, the application user interface includes functionalities that may be used to implement some embodiments of the present disclosure.

FIG. 6 illustrates an application user interface viewed by a user, the application user interface includes functionalities that may be used to implement some embodiments of the present disclosure.

FIG. 7A illustrates an application user interface viewed by a user, the application user interface allows the user to annotate images according to some embodiments of the present disclosure.

FIG. 7B illustrates an application user interface viewed by a user, the application user interface allows the user to annotate images according to some embodiments of the present disclosure.

FIG. 7C illustrates an application user interface viewed by a user, the application user interface allows the user to annotate images according to some embodiments of the present disclosure.

FIG. 8 illustrates a block diagram illustrating a controller that may be embodied in one or more of mobiles devices and utilized to implement some embodiments of the present disclosure.

FIG. 9 illustrates a network diagram including a processing and interface system for a virtual Memory book is illustrated.

FIG. 10 illustrates a block diagram of an image capture apparatus and associated server.

FIG. 11 illustrates apparatus for generating an image for media entry with enhanced depth.

FIG. 12 illustrates a timeline including an original event and one or more follow up events.

FIG. 13 illustrates types of dynamic imagery and functionality according to some implementations of the present invention.

FIG. 14 illustrates method steps that may be performed in some implementations of the present invention.

### DETAILED DESCRIPTION

The present disclosure provides for apparatus and methods to generate dynamic stickers, emoji images or other type of dynamic imagery and animations based upon one or more conditions proximate to a sender's network access device and a receiver's network access device. The dynamic image entries are based upon an environmental condition. The dynamic image entry may be placed at a spatial designation within the generated image. Conditions proximate to a sender's network access device and a receiver's network access device, may include, by way of non-limiting example: motion, weather (hot, cold, windy, breezy, wet, humidity) motion, acceleration, vector speed, leaning in a certain direction, vibrations, dancing, shaking, biometric and other personally identifiable data methods, camera & microphone input can all be registered by the device used to generate a message and/or receive a message and control display of the dynamic imagery based upon the environmental condition registered. In some embodiments, the user device ascertains certain conditions itself, such as vibration and accelerating motion. In other embodiments, the conditions may be referenced via a source accessible via a communications network. For example, weather at a location of a user device will require that the user device determine a location, such as via a GPS reading and then access a weather service via the Internet.

According to the present invention, the Sender may send one or more of: an animation; other dynamic image; and an instruction to generate a dynamic image; to a Recipient device. The animation, dynamic image and/or instruction to generate a dynamic image may be based upon a weather condition determined by location and weather service. In other embodiments the server may generate animations based on an individual's device data. Other combinations and variations are within the scope for the present invention. Conditions used to generate an animation may be ascertained at one or both of the sender unit location, time and condition or the recipient unit location, time and condition. Similarly a time of day specific to a location of a sending or receiving device may be determined and used to modify an animation. Additionally, identifying people individually or in a group as well as animals and other real-life objects may serve as input.

In some specific implementations, a condition registered by smart device, such as receipt of a weather report indicating rain be represented by the image, such as an umbrella; a motion interpreted as rapid shaking may result in a recipient user device vibrating. In some additional aspects, static images may be combined with dynamic images based upon environmental conditions.

The static image entries and the dynamic image entries are each aligned via spatial coordinates, and the dynamic image entries may become animated based upon an environmental condition ambient to a device that is used to generate the dynamic image entry and/or an environmental condition ambient to a device that is used to display the dynamic image entry.

In some embodiments, a Photo Memory book index may associate a page and Spatial Coordinate with a subject. A subject matter may be a person's name, such as a family member or work colleague or faculty member's name; facial recognition, a group, such as department in and organization, a division, a location or other category. A dynamic image may be placed upon the spatial coordinate of the subject.

In some embodiments, an apparatus includes mobile device, such as a tablet or a mobile phone, a computer server accessible with a network access device via a digital communications network and executable software stored on the apparatus and executable on demand. Also computerized glasses or other individually manage devices. The software operative with the apparatus to cause the apparatus to transmit over the digital communications network game comprising a plurality of images, receive via the digital communications network a designation of Sending User selected image comprising the plurality of images, receive via the digital communications network an Cartesian Coordinate Communication associated with the Sending User's selected image, receive via the digital communications network a suggested placement position of the Cartesian Coordinate Communication in the specific augmented reality room the Receiving User is currently visiting, determine at least one user associated with the selected image and generate an animated image comprising the image and the Cartesian Coordinate Communication associated with the selected image, said augmented reality room comprising the image and the Cartesian Coordinate Communication being available upon request to the at least one user associated with the selected image.

In some embodiments, Augmented Reality games include a processor and executable software, executable upon demand to allow a user to provide an animation to a player or other subject matter associated with a Spatial Coordinate. Additionally the server may generate the dynamic images and send to specific users for use in games.

In some embodiments, an apparatus is disclosed capable of embodying the innovative concepts described herein. Image presentation can be accomplished via certain multimedia type interface. Embodiments can therefore include a, handheld, game controller; tablet, PDA, cellular or other mobile or handheld device, glasses or contact lenses, including, in some embodiments, voice activated interactive controls.

### Glossary

As used herein the following terms will have the following associated meaning:

“Mobile device” as used herein is a wireless mobile communications network access device for accessing a server in logical communication with a communications network. The mobile device may include one or more of a cellular, mobile or CDMA/GSM device, a wireless tablet phones, personal digital assistants (PDAs), “Mobile network” as used herein includes 2G, 3G, 4G internet systems and wireless fidelity (Wi-Fi), Wireless Local Area Network (WLAN), Worldwide Interoperability for Microwave Access (Wi-MAX), Global Mobile System (GSM) cellular network, spread spectrum and CDMA systems, time division multiple access (TDMA), and orthogonal frequency-division multiplexing (OFDM). The mobile device is capable of communicating over one or more mobile network. A mobile device may also serve as a network access device.

“Network Access Device” as used herein refers to an electronic device with a human interactive interface capable of communicating with a Network Server via a digital communications network.

“Spatial Coordinate” as used herein refers to a designation of a particular location on a page. Specific examples of Spatial Coordinate include Cartesian Coordinates and Polar Coordinates.

“User” as used herein includes a person who operates a Network Access Device to access an Augmented reality room. Examples of Users may include that plays the within the App.

“User interface” or “Web interface” as used herein refers to a set of graphical controls through which a user communicates with the App. The user interface includes graphical controls such as button, toolbars, windows, icons, and pop-up menus, which the user can select using a mouse or keyboard to initiate required functions on the App.

“Wireless” as used herein refers to a communication protocol and hardware capable of digital communication without hardwire connections. Examples of Wireless include: Wireless Application Protocol (“WAP”) mobile or fixed devices, Bluetooth, 802.11b, or other types of wireless mobile devices.

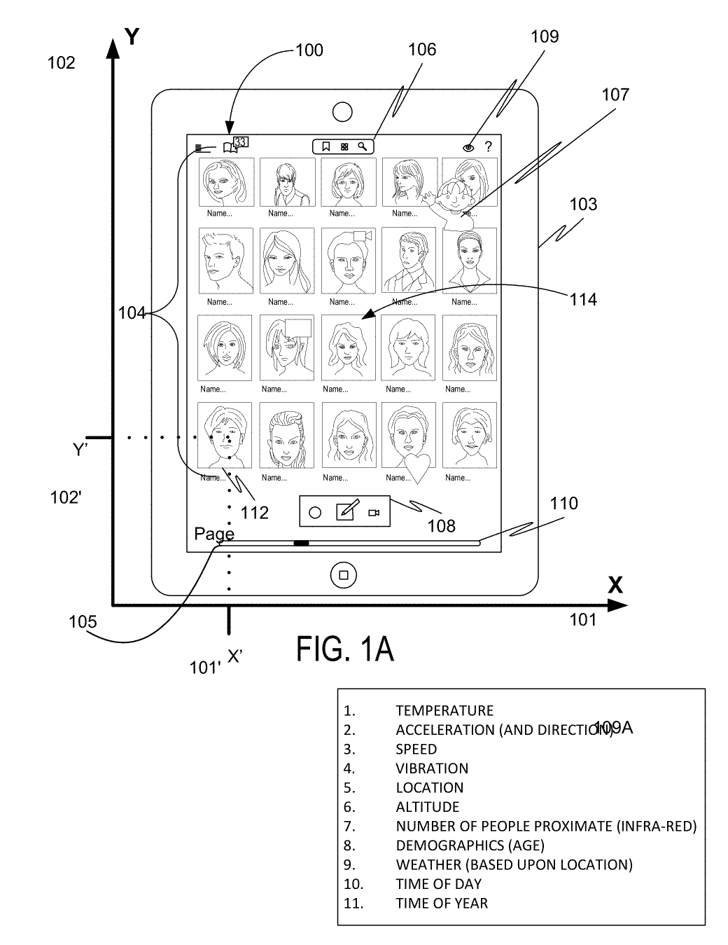

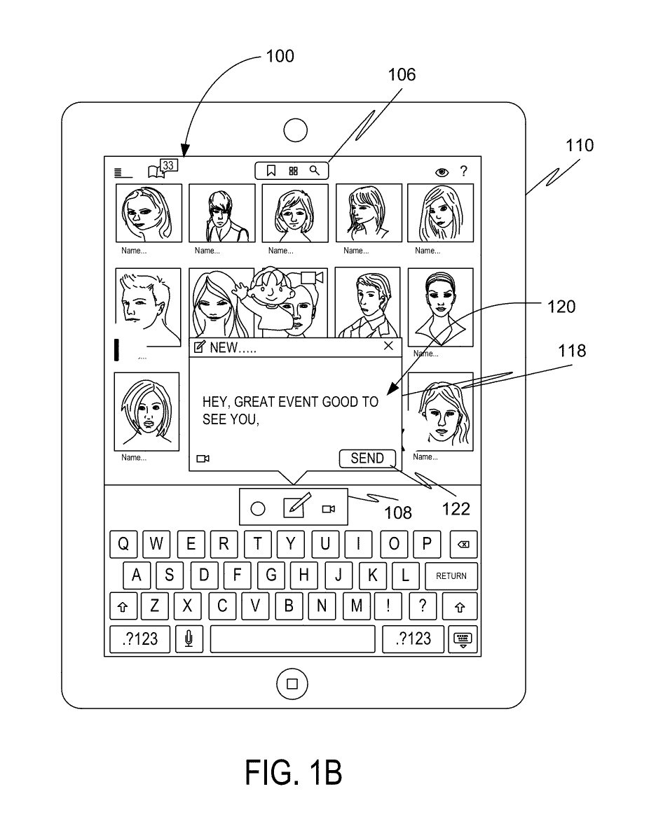

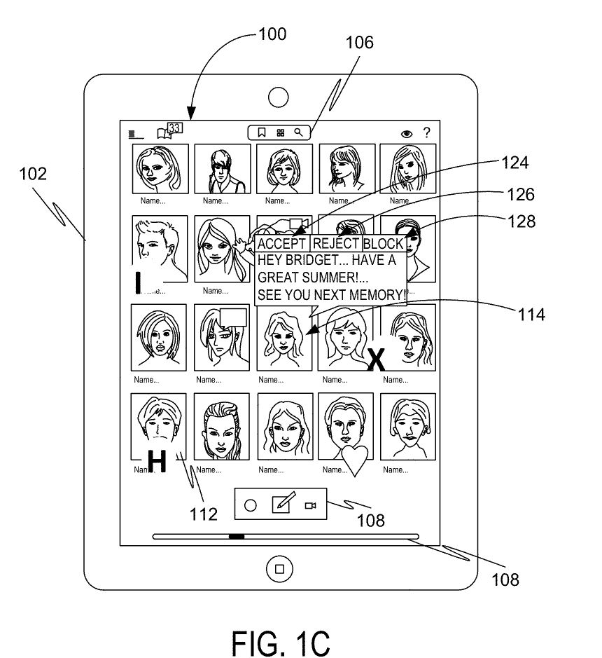

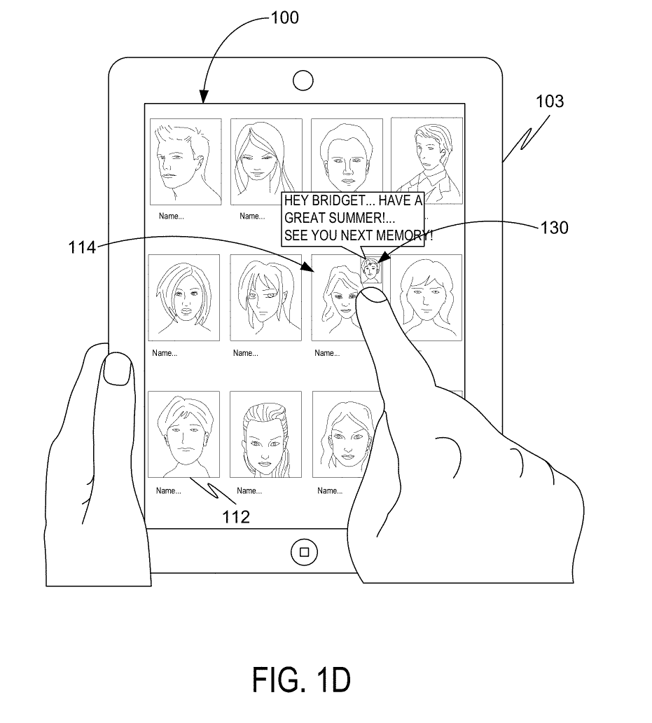

Referring now to FIG. 1A, a block diagram illustrates an exemplary user Network Access Device 103 with a Photo Memory book User Interface 100 displayed thereon. According to the pre invention the user interface 100 includes functionalities that enable dynamic input based upon a condition of an environment of a device used to generate or display the Memory book interface. Typically, a Memory book user interface displays image data 104, such as images of students, in a Memory book as seen by most or all users including students, parents, teachers and administrators. The users may be associated with a same learning institution, same sports team or same organization activity group. Alternatively, the image data 104 may be related to faculty of an organization or university, employees of a same company, members of a group, members of a family or other definable group of people.

The user interface 100 includes image data 104 associated with Spatial Coordinate positions 101-102. A user may designate a Spatial Coordinate 101′ 102′ and operate a User interactive control to provide a media entry associated with the Spatial Coordinate 101′ 102′. Typically, the User media entry will be associated with an image correlating with the Spatial Designation, such as for example an image of a photograph of a student. A user interactive area 106 may receive input from a user and provide one or both of human readable content or human recognizable images.

In some preferred embodiments, a system of Spatial Coordinates 101-102 will not be ascertainable to a user. The user will make a selection of a Spatial Coordinate via a cursor control or touch screen input. For example, a user 112 may input a cursor click on area of a static image that includes a likeness of a student. The area associated with the first user 112 that receives the cursor click will be associated with one or more Spatial Coordinates 101′ 102′. As illustrated, the Spatial Designations may be determined via a Cartesian Coordinate. Other embodiments may include a Polar Coordinate.

According to the present invention, a user defined dynamic image entry 107 may be generated and associated with spatial coordinates of a digital communication and/or a Static Entry. The dynamic image entry 107 is preferably based upon an environmental condition associated with a device that generates the dynamic image entry and/or a device used to display the dynamic image entry. Environmental conditions may include one or more or a temperature in a location from which the dynamic image entry 107 is initiated or otherwise generated; an acceleration of a device from which the dynamic image entry 107 is initiated or otherwise generated; a speed at which of a device from which the dynamic image entry 107 is initiated or otherwise generated; a location of a device from which the dynamic image entry 107 is initiated or otherwise generated; motion of a device from which the dynamic image entry 107 is initiated or otherwise generated; time of day at a location of a device with which the dynamic image entry 107 is initiated or otherwise generated; weather of a location of a device with which the dynamic image entry 107 is initiated or otherwise generated; a time of year when the dynamic image entry 107 is initiated or otherwise generated or reviewed; an altitude of a device with which the dynamic image entry 107 is initiated or otherwise generated, a vibration of a device with which the dynamic image entry 107 is initiated or otherwise generated; a sound level of an ambient environment of a device used to generate the dynamic image entry; an acceleration of a device with which the dynamic image entry 107 is initiated or otherwise generated; and user interaction with the device.

For example, a dynamic image entry 107 may be generated from a mobile phone being operated by a user who is travelling on a motorcycle at increasing speed and during a rainstorm. A sensor in the mobile phone will register the vibration and the vibration pattern of the phone may be associated with a particular type vehicle (such as a certain model motorcycle). In addition a global positioning system (GPS) device within the mobile phone may note the location of the phone and the phone may contact a weather service which provides data indicating a rainstorm in that location. In addition, a calendar function within the phone may indicate that the date is July 4^{th}. As a result a user generating a dynamic image entry may include an animated image, such as an emoticon that includes a motorcycle in the raining and accelerating with a United States flag for the July 4^{th} holiday. The dynamic image entry may be placed on a static image of a first user 112. In addition, a song or video with some relevance, such as the song: You May Be Right by Billy Joel may play, or a sound of an engine revving.

Environmental conditions associated with a device that displays a dynamic image entry 107, may include one or more of: a temperature in a location from which the dynamic image entry 107 is displayed or otherwise reviewed; an acceleration of a device from which the dynamic image entry 107 is displayed or otherwise reviewed; a speed at which of a device from which the dynamic image entry 107 is displayed or otherwise reviewed; a location of a device from which the dynamic image entry 107 is displayed or otherwise reviewed; motion of a device from which the dynamic image entry 107 is displayed or otherwise reviewed; time of day at a location of a device with which the dynamic image entry 107 is displayed or otherwise reviewed; weather of a location of a device with which the dynamic image entry 107 is displayed or otherwise reviewed; a time of year when the dynamic image entry 107 is displayed or otherwise reviewed or reviewed; an altitude of a device with which the dynamic image entry 107 is displayed or otherwise reviewed, a vibration of a device with which the dynamic image entry 107 is displayed or otherwise reviewed; a sound level of an ambient environment of a device used to display or otherwise review the dynamic image entry; and acceleration of a device with which the dynamic image entry 107 is displayed or otherwise reviewed.

In still another aspect of the present invention, a user may activate an environmental data user interactive device 109, such as a switch or GUI, to display the actual data 109A associated with a dynamic image entry 107. In this manner, a first user 113 may generate a dynamic image entry 107 with a first device and have a first set of data associated with the first device at the time of generation of the dynamic image entry 107 and a second user 114 may access the data recorded and/or associated with the first user 112 and the first user device.

In some embodiments, a second device used to display or otherwise review the dynamic image entry 107 may generate additional data descriptive of an environments of the second user device and the second user may additionally access the data descriptive of an environments of the second user device. The dynamic image entry 107 may be animated based upon reference to one or both of the data descriptive of the environment of the first user device and the second user device.

In various embodiments of the present disclosure, interactive areas may include, by way of a non-limiting example, one or more of: a) a user interactive area 106 that allows a user to search an index for Spatial Coordinates that correspond with subject matter, such as images or text descriptive of a particular person or subject; b) a user interactive area 108 that allows a user to provide a Memory book Entry according to Spatial Coordinates and page selected; c) a user interactive area 110 that allows a user to scroll 105 to view content, such as images of students in the Memory Book. The user interface 100 may be provided by a software application installed on a network access device 103, such as a mobile device. Alternatively, the user interface 100 may correspond to a webpage obtained from a website. The software application or the website may interact with a Memory book web service hosted on a computerized network server to provide the user interface 100 on the network access device 103.

A user, such as a first student, viewing the user interface 100 on a Network Access Device 103 may select an area associated with the first user 112 of a User Interface 100 that is associated with a subject a Memory book Entry. In some embodiments, the Memory book Entry may be for the benefit of a second user, such as a second student. The area selected by the first user 112 may, for example, include an image of themselves, or another subject. An area may be selected according to Spatial Coordinates. The Spatial Coordinates designate a particular location on a User Interface. According to the present disclosure, portions of a static image of a Memory book page, such as a PDF image may be associated with a particular subject. For example, Spatial Coordinates X′ and Y′ may be associated with an image the first student on a particular page.

Alternatively, a user may tap on Spatial Coordinates that correspond with a chosen subject, such as an image of a student, which may represent a second user 114, or use the user interactive area 106, which may comprise a search tool, and an associated index that matches Spatial Coordinates and page numbers with subject matter. After a particular Spatial Coordinate has been indicated, a user may make a Memory book Entry into a Memory book associated with a particular user. In some embodiments, a first user may enter a Memory book Entry into multiple Memory book volumes associated with multiple Memory book owners in a single-entry action by designating multiple destination Memory books.

Referring now to FIG. 1B, some embodiments, the user interface 100 displays a text box 118. A first user may select a type of Memory book Entry. Memory book entries may include, for example, one or more of: a text message, an emoticon, free-style drawing, a video and an audio message. A user may select a type of Memory book Entry an initiate its entry via an appropriate option from the user interactive area 108. Alternatively, when a user taps Spatial Coordinates associated with an image of a second user 114, or uses a user interactive area 106, which may comprise a search tool, the user interface 100 may show a drop-down menu from which the first user 112 may select the type of a Memory book Entry.

Further, in some embodiments, a speech-to-text converter may be used to convert an audio Memory book Entry into text. Yet further, in some embodiments, the first user 112 may designate Spatial Coordinates associated with an image of the second user 114 and link a captured image (selfie) or initiate a video recording of the first user 112 speaking to the second user 114. The captured image or the recorded video is then uploaded on the Memory book Web Server. A recorded image may be a “selfie” message recorded and uploaded. The first user 112 may also select a location for a Memory book Entry on the user interface 100. Further, in some embodiments, the first user 112 may send the same message to multiple students by selecting multiple students the user interface 100. Yet further, in some embodiments, the first user 112 may select an interest group or a family group and to send a same message to members selected as a group.

In some exemplary embodiments, the first user 112 selects an option from the user interactive area 108 to provide a Memory book Entry. Accordingly, the user interface 100 displays, referring to FIG. 1B the text box 118. Then, the first user 112 types a text 120 in the text box 118. The text 120 may read, for example: “Hey Bridget . . . great to see you! Finally, the first user 112 clicks on a “send” button 122 to submit the text 120. Further, when the text 120 is submitted, the mobile device of the first user 112 may determine the location of the first user 112 and send the location information along with the text 120 to the Memory book Web Server. Further, in some embodiments, the location of the first user 112 may be displayed along with a Memory book Entry on the user interface 100. In addition, a date and time stamp may be displayed along with a Memory book Entry.

In some embodiments, each Memory book Entry received by the Memory book Web Server is associated with a universally unique identifier (UUID). The UUID may be referenced to track and manage Memory book Entries.

In some additional embodiments, a Memory book may include a dynamic book length feature wherein a user may add additional pages to a Memory Book. The additional pages may include images, text and/or video content. The additional pages may be designed and decorate to commemorate time spent by users together. Similarly, an interactive feature in a user interface may allow a User to click on an image and start a video associated with the image. In some embodiment the additional data includes environment based dynamic emotional or other dynamic imagery.

Referring now to FIG. 1C a user interface 100 is illustrated that may be displayed on a mobile network access device of the second user 114. The Memory book Web Server may transmit a notification to the second user 114, wherein the notification includes information about a Memory book Entry received from the first user 112. As shown, in some embodiments, the user interface 100 conveys the displays the Memory book Entry, such as a text 120 message submitted by the first user 112 for the second user 114. The user interface 100 allows the second user 114 to accept or reject the Memory book Entry with text 120 by using an interactive control, such as one of an “accept” button 124 and a “reject” button 126.

If the second user 114 rejects the Memory book Entry with text 120, it does not become associated with the Memory book, or other media volume associated with the second user 114. Some embodiments may also include a “block” function 128, which may be used to completely block the first user 112 from sending more Memory book Entries. For example a second user 114 may use the “block” button 128 if the text 120 is inappropriate; when the second user 114 does not know the first user 112; or if the second user 114 simply does not wish to receive Memory book Entries from the first user 112. A student may also be able to “white list” messages and or provide a Memory book Entries by activating functionality to: “Accept messages from a source”, such as, for example, a user identified as Student 123.

Referring now to FIG. 1D an illustration of the user interface 100 viewed by the second user 114. The user interface 100 showing the accepted Memory book Entry in places as seen by the second user 114. Next to the second user's 114 large image, there is a small icon 130 with the image of the first user 112. The user interface 100 places the accepted provide a Memory book Entries on a digital provide a Memory book Entry layer on top of the students' images, allowing the second user 114 to turn-on and turn-off a Memory book Entry layer to make it visible and invisible respectively.

In some aspects, multiple users may send private one-to-one messages to other students, and respective users may accept or reject Memory book Entries individually; therefore, each user may view and own a different digital copy of their Memory book. For example, the first user 112 may provide a Memory book Entry on multiple students. Some of the students may accept a Memory book Entry and some may reject. Accordingly, each user may view a different version of the same memory book.

Web Interface

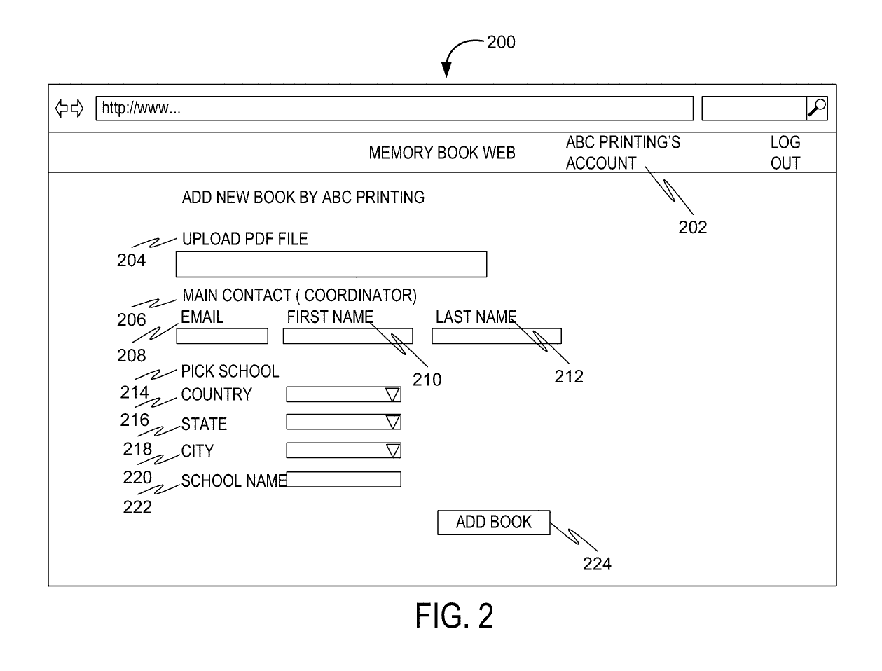

Referring now to FIG. 2 an illustration of a web interface 200 according to some aspects of some embodiments of the present disclosure. The web interface 200 includes functionalities that may be used to implement some embodiments of the present disclosure. The web interface 200 may include a representation of a static image correlating with a Memory book page and Spatial Coordinates corresponding with areas of each static image. The third-party service provider may be a printing company (such as ABC printing 202) that specializes in preparing memory books or an Internet company providing the Memory book Web Server to learning institutions to upload and view their memory books.

In some embodiments, the web interface 200 includes a web form that allows an administrator to add a new Memory book to the Memory book Web Server. The administrator may upload a new Memory Book using an “Upload PDF file” form field 204. Further, the new book may be uploaded in one of PDF, DOC, DOCX, PPT and PPTX formats. Next, the administrator may add a main contact for the Memory book using a “Main Contact” form field 206. The “Main Contact” form field 206 allows the administrator to provide an email address 208, a first name 210 and a last name 212 of the main contact. A “Pick” form field 214 allows the administrator to include organization information such as a country 216, a state 218, a city 220 and an organization name 222.

Further, the “Pick Organization” form field 214 may allow the administrator to fill in a year, a group and a title of the Memory book (not shown). In addition, the administrator may use an “Add book” button 224 to submit the static memory book images to the Memory book Web Server. Once the static memory book entries are uploaded with most or all the required information, the Memory book Web Server generates a unique master book ID per upload. The book ID may be generated in the format: “organization name year group/title name”. The Memory book Web Server provides a confirmation when the book is uploaded successfully.

The Memory book Web Server may provide access to memory books to users including, for example: students, faculty and parents in exchange for a payment. Further, advertisements may be added to the web interfaces (including the web interface 200) provided by the Memory book Web Server. Some examples of the advertisements include banner advertisements, pop-up advertisements, and the like. The administrator may provide hyperlinks to specific advertisements, such as, by way of non-limiting example, for framed or poster board versions of Memory book images and Memory book Entries, for products that may interest the users, for a fundraiser for the organization or other purpose. Alternatively, the administrator may provide advertisements using a third-party Internet advertising network including for instance Google Adwords®, Facebook Ads®, or Bing® Ads. The third-party internet advertising networks may provide contextual advertisements.

Further, web interfaces may allow an administrator to manage accounts, create user accounts, reset passwords, delete books and add books on the Memory book Web Server. Moreover, the web interfaces may provide one or more features to the administrators including defining administrator rights, selecting administrator users, re-uploading book PDF, updating book information, inviting users, un-inviting users, sending incremental invites, displaying user statistics, inserting new pages to the Memory book Web Server, tracking revenue details and managing advertisements.

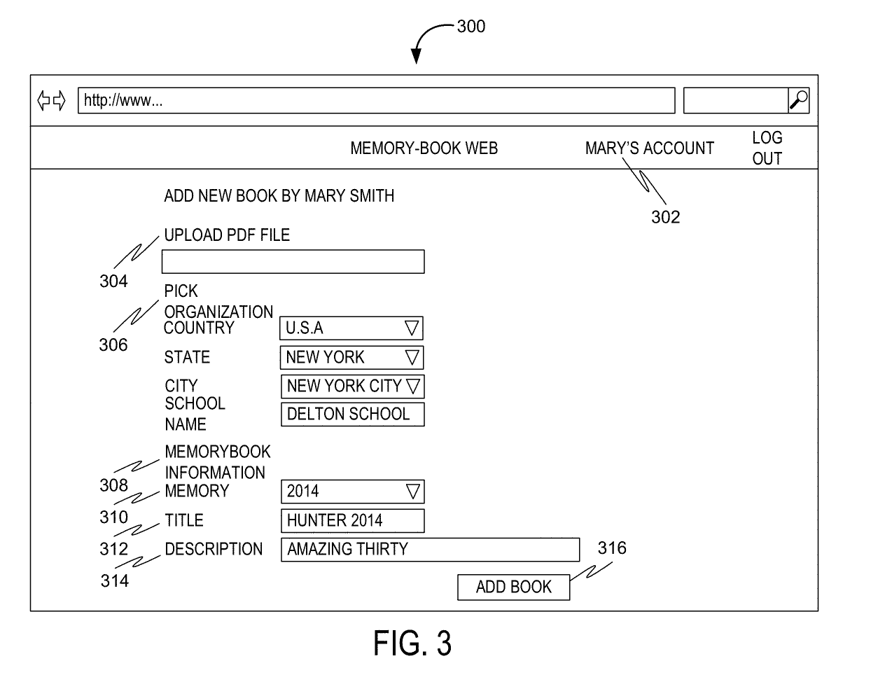

Referring now to FIG. 3 a web interface 300 is illustrated, that may be viewed by a main contact (i.e. Mary 302). The web interface 300 includes functionalities that may be used to implement some embodiments of the present disclosure. The web interface 300 may, for example, include a web form that allows Mary 302 to add a new memory book to the Memory book Web Server. The web interface 300 is similar to the web interface 200 explained in detail in conjunction with FIG. 2 above.

Functionality may include, for example, uploading static images of a media volume, such as a Memory book. An “upload PDF file” form field 304 allows for uploading one or more static images associated with a Memory book or other volume. In addition, a library of dynamic images that may be included in a memory and dynamic based upon an environment of a device accessing the Memory book may be uploaded or designated on the server. A “Pick Organization” form field 306 associates the uploaded static images with a particular organization. Other embodiments may include static images of a volume associated with a group of people, such as a family, a company, a department, or other definable group. The web interface 300 may further include “memory book information” form fields 308 year 310, a title 312 and a description 314. Once the required information is provided, a user such as Mary 302 may use an “Add Book” button 316 to submit the memory book to the Memory book Web Server.

Additional functionality may include printing Memory book entries on a transparent medium, such as a velum or acetate page and arranging for the transparency to be inserted over a physical Memory Book. The spatial coordinates of the Memory book entries will align with the designated location for a Memory book entry.

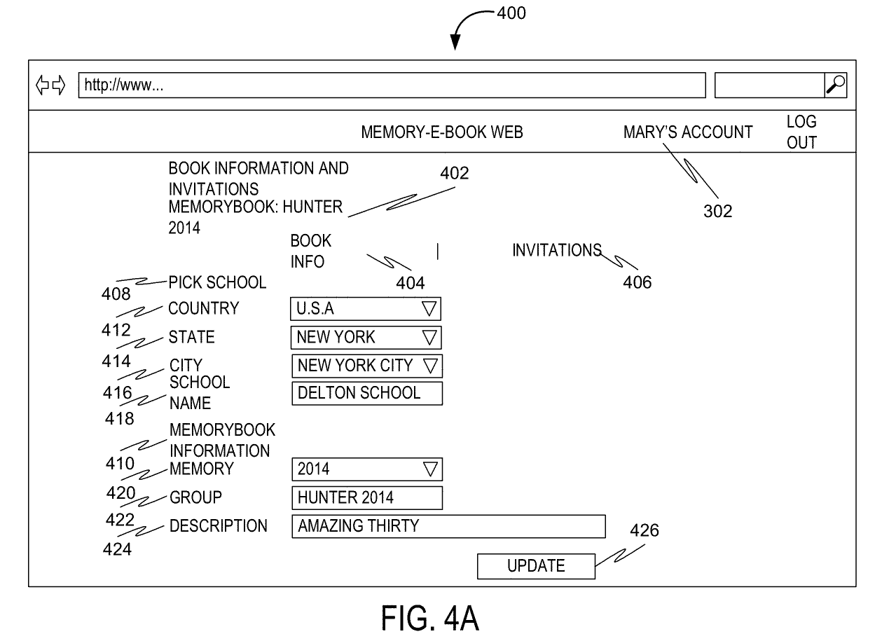

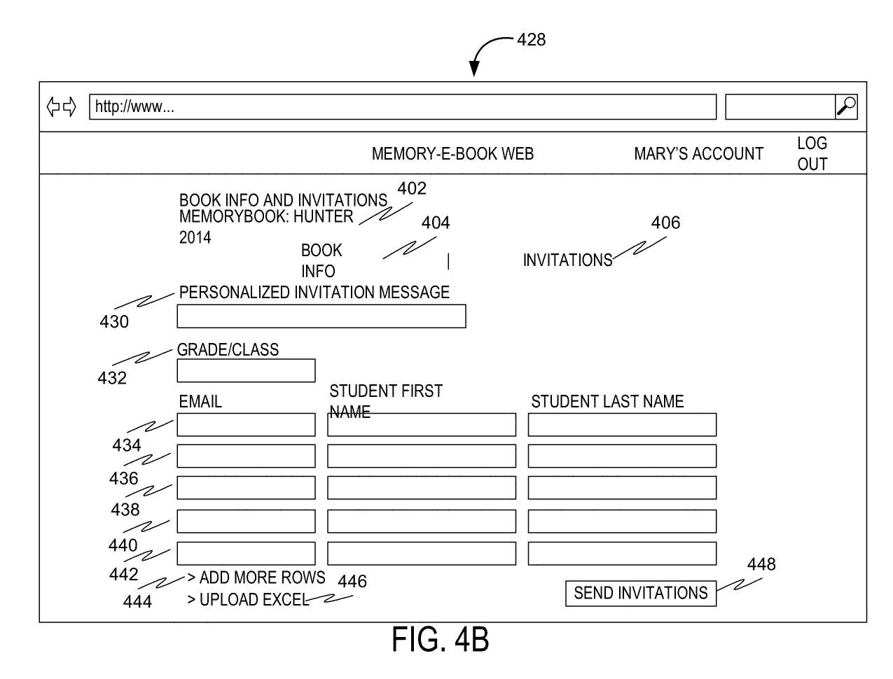

Referring now to FIG. 4A an illustration of a web interface 400 viewed by a user Mary 302, the web interface 400 includes functionalities that may be used to implement some embodiments of the present disclosure. In some embodiments, web interface 400 may include a web form that allows Mary 302 to update a memory book. The web interface 400 shows that a title 402 of the memory book is “Hunter 2014”. Further, the web interface 400 may show two or more tabs such as: a “book info” tab 404 and an “invitations” tab 406. When the “book info” tab 404 is selected, the web interface 400 shows the fields “pick organization” 408 and “memory book information” 410. The “pick organization” field further includes one or more fields including a country 412, a state 414, a city 416, and an organization 418. In the example shown, the country 412 is “U.S.A.”, the state 414 is “New York”, the city 416 is “New York City”, and the organization 418 is “Delton Organization”. The “memory book information” field 410 further includes one or more fields including a year 420, a group 422 and a description 424. In the example shown, the year 420 is “2014”, the group 422 is “Hunter 2014” and the description 424 is “Amazing thirty”. Once the required information is provided, the main contact uses an “update” button 426 to update the memory book.

Referring now to FIG. 4B an illustration of a web interface 428 viewed by user Mary 302, when the “invitations” tab 406 is selected by Mary 302. Mary 302 may send invitations to users (including students and parents) using the web interface 428. Mary 302 enters an invitation message in a “personalized invitation message” field 430. If a personalized invitation message is not provided, then a default message is used. Further, a “grade/class” field 432 is used to indicate the appropriate grade or class. Yet further, the web interface 428 shows a list of rows 434, 436, 438, 440 and 442. Each row 434, 436, 438, 440 and 442 allows Mary 302 to provide details for a user including email, first name and last name of the user. Mary 302 may manually fill in the rows 434, 436, 438, 440 and 442. Further, more rows may be added using an “add more rows” feature 444. Alternatively, Mary 302 may upload a Microsoft EXCEL® document containing the details a user using an “upload excel” feature 446. The Memory book Web Server automatically parses the uploaded Microsoft EXCEL® document to obtain names and email addresses of users. Finally, Mary 302 sends out the invitations using a “send invitations” button 448. Thereafter, the Memory book Web Server generates a unique book view ID for each student. The book view ID may be prepared in format such as “book ID_Email_member's name_member”. This book view ID is included in the invitation message sent to most or all users. Further, the invitation message may include a hyperlink to the memory book, which when activated directs the user to the relevant memory book on the Memory book Web Server. For each invitation, the Memory book Web Server may receive an acknowledgement indicating a successful or a failed delivery.

Application User Interface

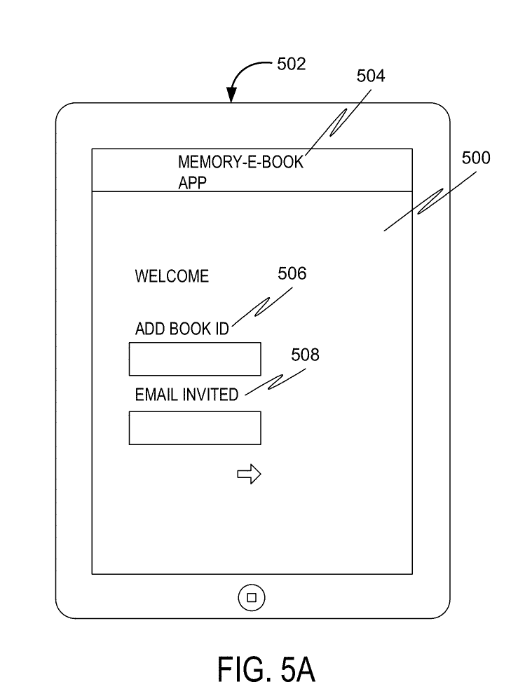

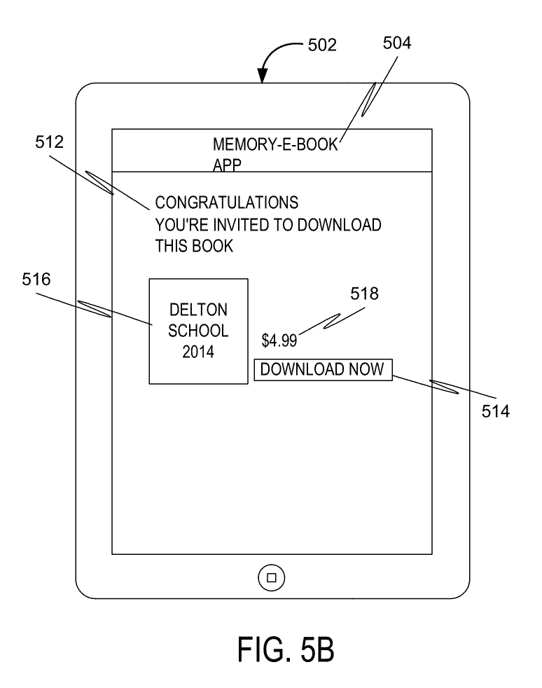

Referring now to FIG. 5A an illustration of an application user interface 500 viewed by a user (a student or a parent) on a mobile device 502, the application user interface 500 includes functionalities that may be used to implement some embodiments of the present invention. The application user interface 500 may be displayed when the user receives the invitation message from Mary 302 and follows the hyperlink provided in the invitation message to access the relevant memory book. The application user interface 500 may be provided by a “Memory book” application 504 installed on the mobile device 502. However, if the “Memory book” application 504 is not already installed on user's mobile device 502, then the user may be prompted to install the “Memory book” application 504. For example, the mobile device may be an Android™: iOS™ or other operating system based device. In some embodiments, a user may access an application providing website such as Apple, Google Play, Amazon or other App store to install a “Memory book” application 504.

The application user interface 500 is a web form including an “add book ID” field 506 and an “email invited” field 508. The user enters the book view ID obtained from the invitation email into the “add book ID” field 506 and the email ID in the “email invited” field 508. If the book view ID and the email ID are correct, the “Memory book” application 504 displays an application user interface 512 on the mobile device 502 as shown in FIG. 5B. The application user interface 512 provides a “download” button 514 that allows the user to download “Delton Organization 2014” memory book 516 shared by Mary 302 via the invitation message. The “Delton Organization 2014” memory book 516 may be provided at a price. As shown, the application user interface 512 displays a price 518 of the “Delton Organization 2014” memory book 516 to be $4.99. Accordingly, the “Memory book” application 504 also provides a payment workflow that allows the users to pay the required amount. Further, the revenue generated by selling the memory books may be shared among one or more of an Internet company providing the Memory book Web Server, a local printer and an organization. Accordingly, the Memory book Web Server tracks revenue sharing details. In an alternate embodiment, the user accesses the hyperlink in the invitation message and the relevant memory book is automatically downloaded and added to the “Memory book” application 504 installed on the user's mobile device 502. Further, the “Memory book” application 504 provides a feature for batch migrating memory books to another mobile device.

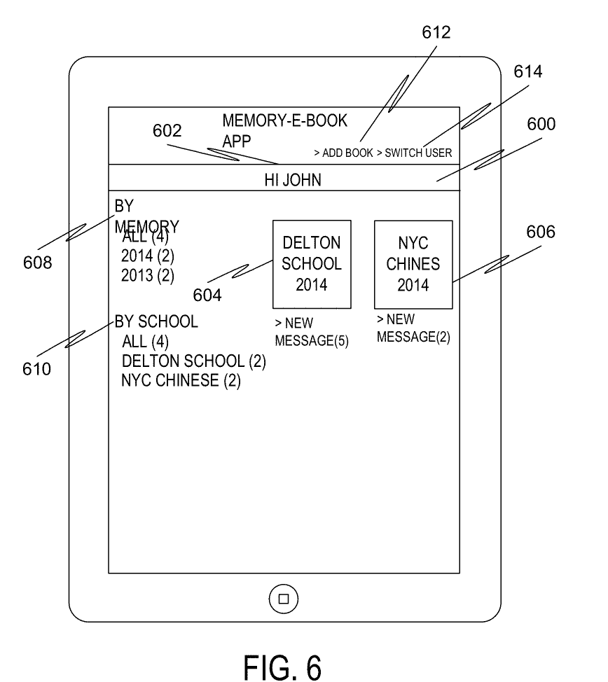

Referring now to FIG. 6, an application user interface 600 that may be presented to a user (i.e. John 602) is illustrated. In some embodiments, the application user interface 600 includes functionalities that may be used to implement various aspects of the present disclosure. Some embodiments may include an application user interface 600 that presents memory books that John 602 has access to; for example, a “Delta Organization 2014” memory book 604 and a “NYC Chinese 2014” memory book 606. Further, John 602 may access memory books by selecting an appropriate year from a list 608 or by selecting an appropriate organization from a list 610. Further, John 602 can add more memory books using an “add book” button 612. When the “add book” button 612 is activated, John 602 is shown the application user interface 500.

In another aspect, the mobile device may be shared among multiple users. Accordingly, a “Switch User” button 614 may be used to switch the “Memory book” application 504 among multiple users. Further, the “Memory book” application 504 allows a user to send messages to another user across memory books. For example, a user in the “Delton Organization 2014” memory book 604 may send a message to another user in the “NYC Chinese 2014” memory book 606. Further, the “Memory book” application 504 allows a user to send personal notes to another user, wherein the personal notes are not publicly accessible. Moreover, a user may invite relevant users from the “Memory book” application 504. For example, a student may invite his parents or friends outside organization to access the memory book.

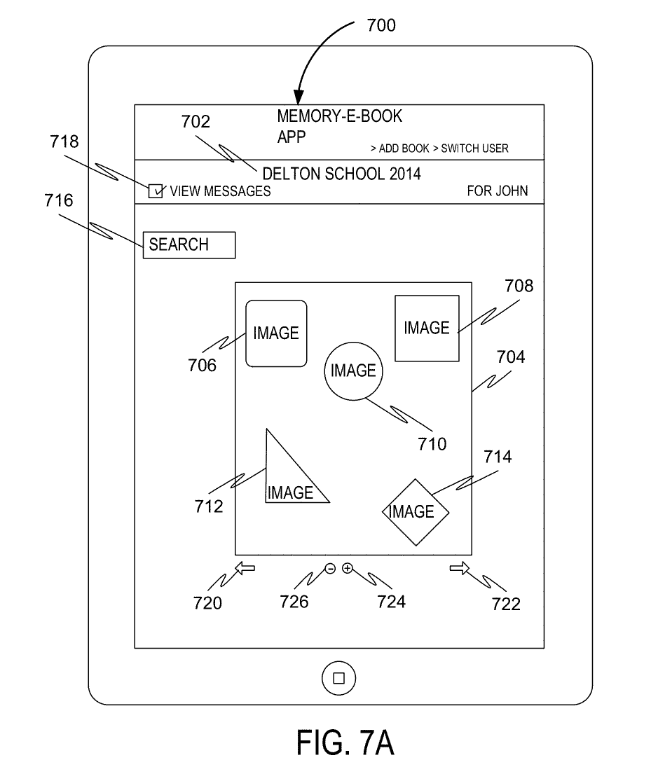

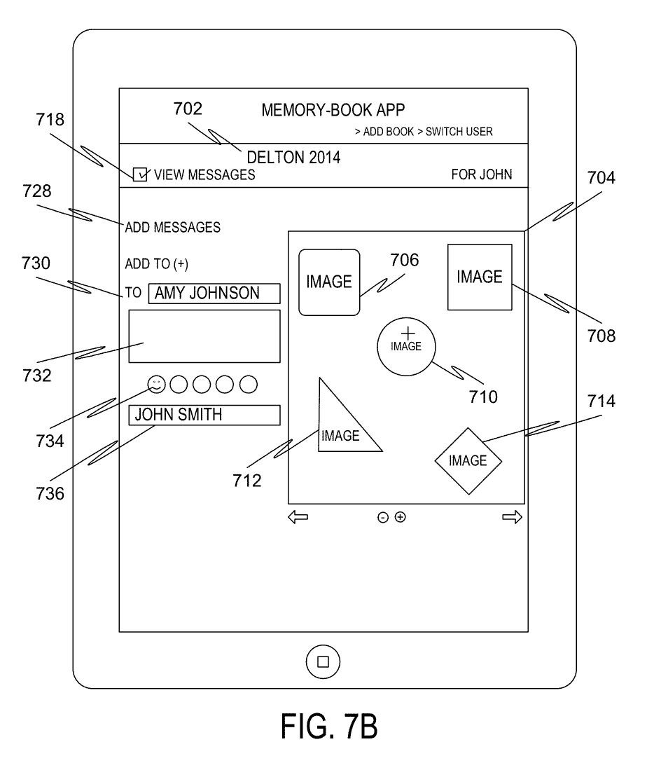

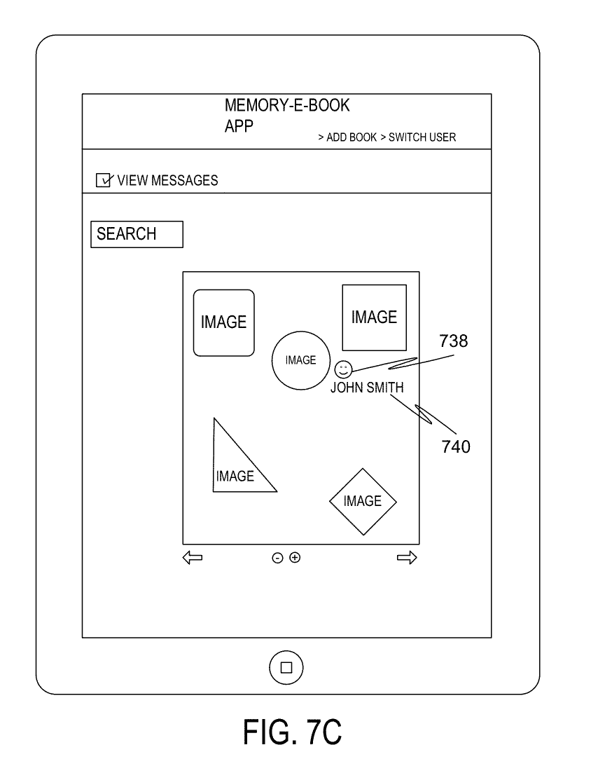

Referring now to FIG. 7A an application user interface 700 is illustrated with an exemplary memory book presented as “Delton organization 2014” memory book 702 to John 602. The application user interface 700 includes a user interactive area 704 showing images 706, 708, 710, 712 and 714. The images 706, 708, 710 and 712 include images of people, places or things relevant to in the “Delton Organization 2014”. John may also provide a dynamic image 714 that is animated based upon an environmental condition of John's device or another user viewing the Memory book. John 602 may search students and messages using a “Search” button 716. Further, John 602 may view messages or hide messages using a “view images” radio button 718. The “view images” radio button 718 allows John 602 to turn-on or turn-off a Memory book Entry layer. John 602 may turn pages to view other students using arrows 720 and 722. In addition, John 602 may zoom-in or zoom-out of the user interactive area 704 using the controls 724 and 726 respectively.

John 602 may input Memory book Entries for students shown in user interactive area 704. Accordingly, John 602 may select Spatial Coordinates associated with an image, for example, the image 710 from the application user interface 700.

Referring now to FIG. 7B, in response to selection of the image 710, the “Memory book” application 504 shows an “add messages” field 728. The “add messages” field 728 further includes a “To” field 730 showing the name of the student (“Amy Johnson”) in the selected image 710. In some embodiments, the user may add a Memory book Entry in a text area field 732 and add an emoticon 734. The name of the user (i.e. “John Smith”) providing a Memory book Entry may be displayed in a field 736. John 602 may submit a Memory book Entry 738 wherein an emoticon is placed next to the image 710 as shown in FIG. 7C. The name of a Memory book Entry author (“John Smith”) 740 may also displayed next to a Memory book Entry 738.

In some embodiments, a user, such as John 602 may also provide an image of a Memory book Entry including an image, a sticker or a signature, a video as a Memory book Entry, an audio provides a Memory book Entry, a free-style drawing and a data package comprising contact information. Further, the “Memory book” application 504 offers in application merchandize such as stickers, emoticons, icons etc. The users may purchase the merchandize and use to provide a Memory book Entry in a memory book. The second student (“Amy Johnson”) receives notification about a Memory book Entry 738. The “Memory book” application 504 allows a second student to accept or reject a Memory book Entry 738. Further, the second student may report spam or inappropriate message and block John 602 from posting provide a Memory book Entries in future. The “Memory book” application 504 also provides latest activity summary to the users.

Further, a Memory book server may define various types of users including printer representative, organization representative, parent, and student. For each user type, the Memory book Web Server may define access rights to features of the Memory book Web Server. In an exemplary embodiment, the Memory book Web Server administrator may auto-generate emails and send them to users, and create accounts for various users.

A printer representative may be granted rights to upload static images, such as a PDF images. A parent user may be allowed to set read or write permission settings for their wards. A student user may be allowed to receive invitation email to access a memory book, self-identify with an image in the memory book, view the memory book, add messages to the memory book, receive message read notices, receive new message notices, receive weekly reminder of new messages or activities and report spam provide a Memory book Entry. In some embodiments, an organization administrator may be provided with functionality to designate a Memory book administrator user.

Mobile Device

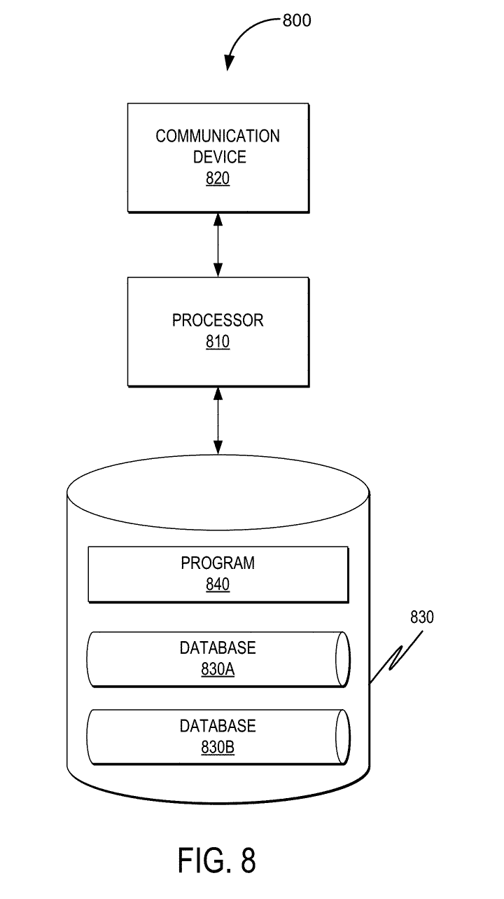

Referring now to FIG. 8, an illustration is provided with a controller 800 that may be embodied in one or more of communications accessible devices and utilized to implement some embodiments of In some embodiments, Communications accessible devices may include, by way of example, a hand held device such as a cellular phone, a pad device, a personal computer, a server, a personal digital assistant, an electronic reader device or other programmable device.

The controller 800 comprises a processor 810, which may include one or more processors, coupled to a communication device 820 configured to communicate via a communication network, such as the Internet, or another cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with software instructions included in the program 840. The processor 810 may also cause the communication device 820 to transmit information, including, in some instances, control commands to operate apparatus to implement the processes described above. The storage device 830 can additionally store related data in a database 830A and database 830B, as needed.

Network Diagram

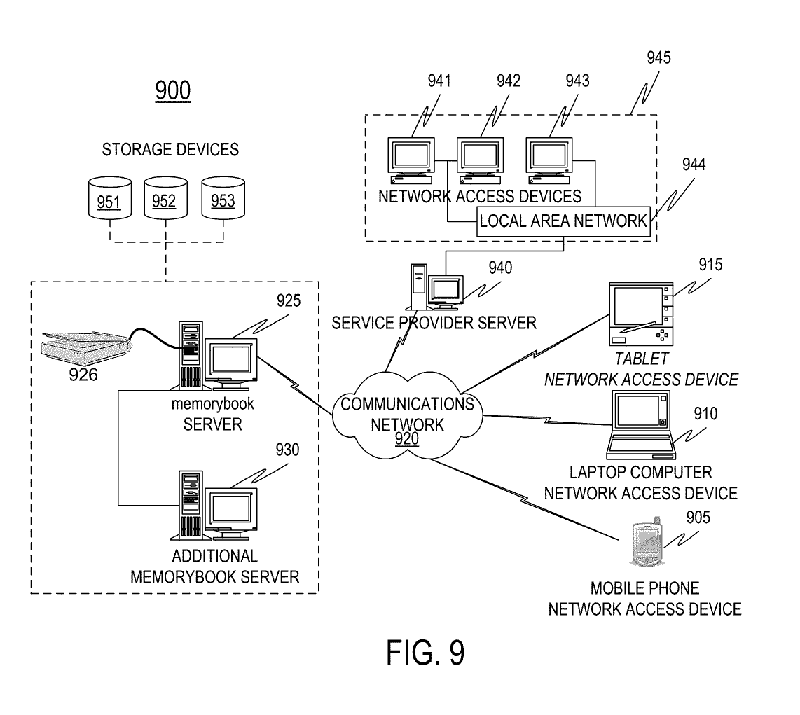

Referring now to FIG. 9, a network diagram including a processing and interface system 900 for generating a Memory book with static image data and Spatial Coordinates is illustrated. The system 900 may comprise a Memory book server 940; support servers 925, 930; Memory book static image and user data storage devices 951, 952, 953; and network access devices 905-915.

An image capture device 926 may provide static image data emulating pages of a memory book volume to the Memory book Server 925. The Memory book Server 925 may associate Spatial Coordinates to areas of respective emulated pages of the memory book volume.

The network access devices 905-915 may allow a user to interface with the system 900. In some embodiments, the system 900 may be linked through a variety of networks. For example, a branch of the system, such as the Memory book provider server 940, may have a separate communication system 945, wherein multiple network access devices 941-943 may communicate through a local area network (LAN) 944 connection. The local network access devices 941-943 may include a tablet, a personal computer, a computer, a mobile phone, a laptop, a mainframe, or other digital processing device.

The Virtual Memory book server 940 may connect to a separate communications network 920, such as the Internet. Similarly, network access devices 905-915 may connect to the Virtual Memory book server 940 through a communications network 920. The network access devices 905-915 may be operated by multiple parties.

For example, a tablet network access device 915 may comprise a cellular tablet. A laptop computer network access device 910 may be a personal device owned by an individual User.

Accordingly, the servers 925, 930, 940 and network access devices 905-915 are separate entities for illustrative purposes only. For example, the Virtual Memory book server 940 may be operated by the SDSP, and the Memory book servers 925, 930 may be integrated into the Virtual Memory book server communication system 945. The Virtual Memory book may also provide a digital assistant network access device 915 to Users. Alternatively, the Virtual Memory book may only provide the access device 915 to users. In some such aspects, the servers 925, 930, 940 may be operated by a third party or multiple third parties, such as, for example, the manufacturers of the Products carried by the vendor.

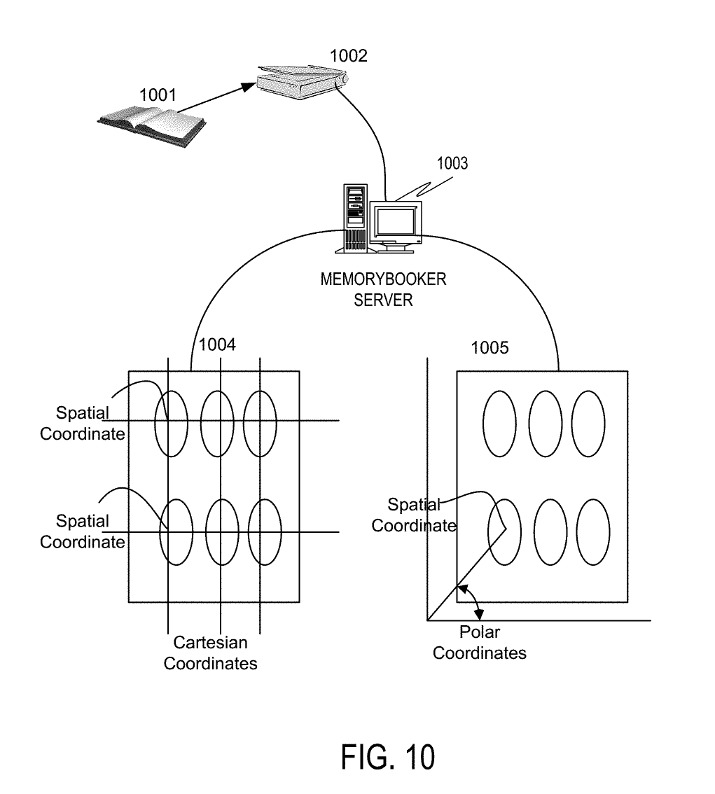

Referring now to FIG. 10 a block diagram illustrating apparatus for generating a Memory book is illustrated. A memory book volume 1001, or other media book is converted by a digital image generator 1002. The digital image generator 1002 may include, for example an image capture device that creates a static image of respective pages of the physical memory book. The digital image generator 1002 may operate, by way of non-limiting example based upon charge-coupled device (CCD) input received from the respective pages of the memory book or other physical volume. In some embodiments, static image data, such as a PDF image may be generated based upon electronic input.

A Memory book Server 1003 may receive the static image data of respective pages of a memory book and correlate areas of the respective pages with Spatial Coordinates 1004-1005. Spatial Coordinates 1004-1005 may include, by way of non-limiting example, one or more of: Cartesian Coordinates, such as an X-Y designation′ and a Polar Coordinate, such as a point on a plane determined by a distance from a fixed point and an angle from a fixed direction.

The Memory book Server may then receive Memory book Entries based upon a page and Spatial coordinate according to the apparatus and methods discussed herein.

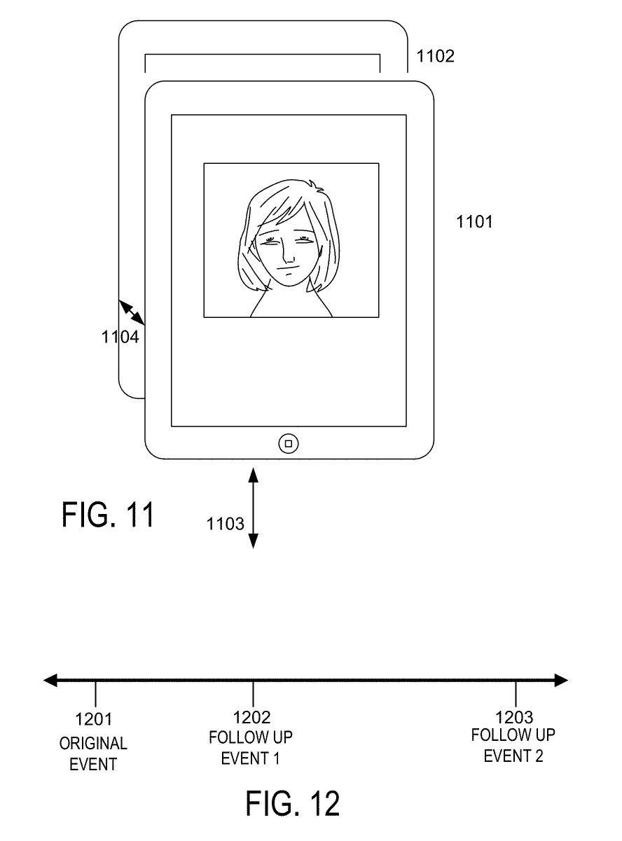

Referring now to FIG. 11, in some embodiments, a Memory book Entry may include an image of a user making the entry, wherein the image has enhanced depth. Enhanced depth may be generated by taking multiple image captures 1101 and 1102 with each image capture taken at a different distance 1103 and 1104 respectively. Post image capture processing may process the captured image data and generate a post-processed image with enhanced depth.

Additional variations may include a Memory book Entry with a panorama of image data. The panorama of image data may be captured via multiple image capture events (digital pictures) taken in a general arc type pattern around a subject. Typically, the subject will include a person making a Memory book entry.

Referring now to FIG. 12, in some embodiments, a Memory book Entry associated with a Spatial Coordinate and page may be periodically appended to with additional media input. For example, a picture of a student taken during a high organization tenure may be accompanied by a picture of the same student at a follow up event. A follow up even may include, by way of example, a high organization reunion, or other event. Some embodiments may also include multiple events 1201-1203 with respective updated Memory book Entries, which may include the original event 1201 and two follow-up events 1202, 1203.

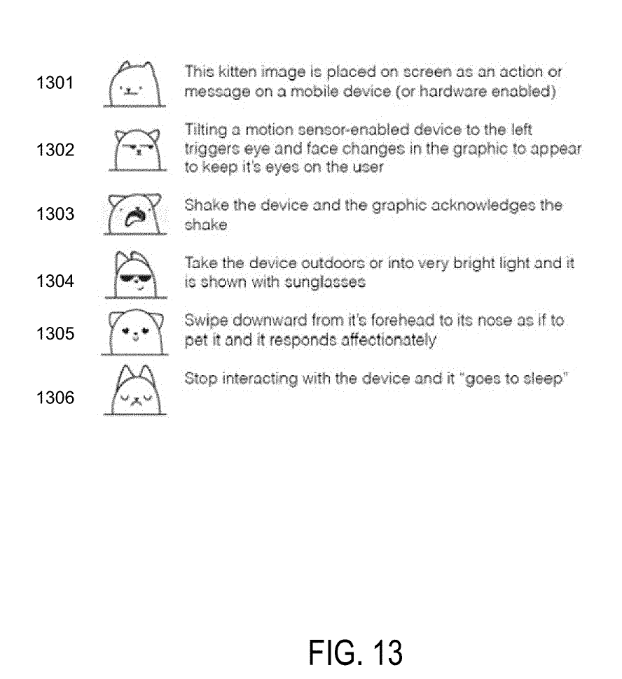

Referring now to FIG. 13, exemplary method steps and associated dynamic images depicted as animation with a functional description of dynamic capabilities of the imagery. As described above the dynamic imagery may be placed at a location on a static page and be used to convey an emotion or other communication. A device monitors conditions experienced by the device and animates or otherwise activates the dynamic functionality of the dynamic imagery based upon conditions experienced by the device. For example, a tablet type device or a smartphone may include motion sensing circuitry, including, for example a motion coprocessor and one or more accelerometers. In response to sensing motion, a dynamic image may change a state of image and become animated. In another example, a barometer reading may have an image respond as if it were experiencing raining, cloudy or sunny weather conditions. Another example may include a proximity sensor that could detect the presence of a device associated with a particular person and provide a change in imagery based upon the presence of the other person.

In some embodiments, a first smart device associated with a first person may monitor a proximate geolocation for the presence of a second smart device associated with a second person. Monitoring may include one or more of: GPS location, WiFi proximity, Bluetooth proximity or other wireless protocol used to determine a relative location of a first smart device and a second smart device. Detection of the first smart device within a threshold distance to a second smart device may cause one or both of the first smart device and the second smart device to generate a user ascertainable manifestation. The user ascertainable manifestation may include, by way of non-limiting example, one or more of: a visual indicator; an audible indicator, and a movement, such as a vibration.

Similarly, detection of a first smart device in proximity to a physical condition may cause the smart device to generate a user ascertainable manifestation of the physical condition, on one or both of the first device and the second device. For example, a motion associated with descending stairs may be ascertained by an accelerometer in the first smart device. The first device may then transmit an indication of the descent of the stairs. The second device may receive a transmission that causes the second device to manifest a descending stairs notification. In preferred embodiments, the manifestation of a condition is an animation, in some embodiments; an animation may be accompanied by one or both of: an audio signal and a movement of the first and/or second smart device.

Although animation apps may respond to device shakes, and touch, the present disclosure provides for emoticons, avatars, stickers and other digital imagery that may be placed at a static location on a screen by a user or sent from a first user to a second user via respective smart devices, as a “live visual message” and a way to express one or more of: a feeling, an emotion, an attitude or condition. For example, a superhero sticker may be sent to indicate strength or power, a scientist character to indicate smarts, etc.

An image processing apparatus may first generate static image data and corresponding Spatial Coordinates as an infrastructure for receiving media input that includes imagery that becomes dynamic based upon physical conditions experienced by a local device. The static image data may replicate pages of a physical memory book, including for example, a school or corporate yearbook. Memory book Entries including media input that would generally correlate to a digital “signing” of a Recipient's Memory Book and may include multiple forms of media as opposed to traditional “writing” placed in traditional memory books. As such the media input is generally related to the image data corresponding with selected Spatial Coordinates. Imagery that becomes dynamic based upon physical conditions experienced by a device upon which the imagery is displayed may include, for example, an animation that changes appearance based upon motion, heat, humidity or other physical condition registered by the device controlling display of the imagery.

Physical conditions experienced by the device upon which the imagery is displayed may also include one or more of: interactive movement and visualization of emoticon triggered by hardware sensors including motion coprocessor, accelerometer, gyroscopes, barometer, compasses, GPS, altitude calculations, micro location (beacons), ambient light sensors, proximity sensors, biometric sensors (fingerprint or facial recognition), voice activation, touch-gestures and duration on screen In some embodiments, the present disclosure includes a digital version of a memory book, which may include a school yearbook, that corresponds with an event or time period.

Unlike social media, the Interactive Memory book provides methods and apparatus to memorialize static images and private communications, essentially recreating a physical volume. In addition, the Interactive Memory book goes beyond pen and ink as a recording medium and provides for more modern recording mediums, such as, for example, one or more of: a multi view digital image, a selfie with dimensional qualities, a voice over, an audio clip, a video clip, a digital time capsule of information that may only be opened at a later date, and a notification function that communicates to a signer when their message is being viewed.

In the example illustrated, at method step 1301 a kitten image is placed on a user interactive screen as an action or a message on a mobile device which may be hardware enabled. The image may appear static, until environmental data is accessed, whereby an animation is based upon the environmental data accessed by the generating device and/or the displaying device.

At method step 1302 a tilting motion (or other data input) registers with a sensor with the device, such as a tilt to the left which causes an animation of the dynamic image entry, such as a change in the picture to have the cat's eyes keep its eyes on the user.

At method step 1303 in the event that the device is shaken, the dynamic image entry may acknowledge the shake with a change in facial expression.

At method step 1304 in the event that the device is taken outdoors, into another source of bright light, the animation may acknowledge by changing its appearance to include sun glasses.

At method step 1305 in the event that the device is swiped downward on a GUI, the dynamic image entry may be animated to portray affection.

At method step 1306 in the event that interaction with the device ceases, the dynamic image entry may register the cessation of activity by causing the animation to sleep.

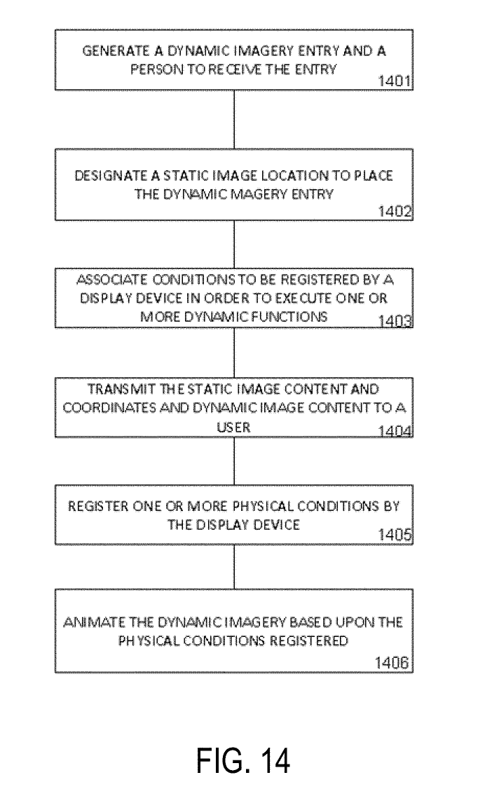

Referring now to FIG. 14, method steps that may be implemented in some embodiments of the present invention are listed. At method step 1401, a first user controlled device, such as a first smart device, may generate a dynamic imagery entry and a person to receive the entry. Alternatively, or in combination with generation of a dynamic imagery entry, a first user controlled device may generate an instruction, such as executable code, for generating the dynamic imagery.

At method step 1402, a static location on a screen of the second user device is generated. The static location may be used as a position on the first user device and/or the second user device to place the dynamic imagery entry.

At method step 1403, a user controlled device, such as a condition capture device, may associate conditions to be registered by a display device. The condition capture device may be an accelerometer or a weather monitoring device, such as a humidity or atmospheric pressure device. The condition capture device may provide input upon which is based an instruction to execute one or more dynamic functions.

At method step 1404, a user controlled device may transmit the static image content and coordinate the dynamic image content to a user.

At method step 1405, a user controlled device may register one or more physical conditions by the display device.

At method step 1406, a user controlled device (e.g. the first smart device or the second smart device) may animate the dynamic imagery based upon the physical conditions registered.

In addition, not only can the user use such apparatus as a tablet, mobile device, but they may also be able to use virtual reality goggles, Google glasses and the like.

The dynamic sticker will be able to be sent out to the general public as they become part of the game or virtual reality advertisement.

Each dynamic sticker or animation will be able to be sent to any specific recipient, sending user can pick which receiving user to send it to.

The dynamic sticker can be used as a new form of advertising that will be able to respond to the environment of the sender or receiver. Data may be taken from an external source based upon the location of the device of the sender or receiver, for example, the weather channel.

Sender will be able to send stickers to any recipient and depending on the game or virtual reality they are currently playing will receive the animation or sticker that is responding to their own specific environmental conditions.

If user is playing an augmented reality game such as Pokemon® Go, characters such as monsters or other creatures can be placed in certain locations for specific recipients to find and win prices.

Such characters and animated objects can be rendered based on environmental conditions and geographical locations.

Company's may make animated objects or characters available for users to find that are geographically located within their store or place of business to draw more individuals into draw up more business.

Characters and animated objects will respond to the environment they are placed in according to such parameters as weather, noises, and other environmental conditions.

### CONCLUSION

A number of embodiments have been described. While this specification contains many specific implementation details, there should not be construed as limitations on the scope of any disclosures or of what may be claimed, but rather as descriptions of features specific to particular embodiments of in some embodiments.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. An image generating apparatus for providing an infrastructure for generating an interactive communication based upon a dynamic replication of a condition determined proximate to a user device, the apparatus comprising:
a condition capture device for generating digital data representative of at least one condition proximate to a first smart device;
one or more computer servers for post processing the digital data representative of least one condition proximate to a user device, said one or more computer servers in logical communication with the condition capture device and accessible via said first smart device via a digital communications network; and
executable software stored on the one or more computer servers and executable on demand, the executable software operative with the one or more servers to cause the apparatus to:
receive the digital data representative of at least one condition proximate to the first smart device;
associate Cartesian Coordinates with specific segregated spatial areas of a display associated with the first smart device;
designate an area within the segregated spatial areas to post a dynamic image entry;
generate a dynamic image entry comprising an animation and based upon the condition proximate to the first smart device; and
transmit over the digital communications network to the first smart device, a first interface comprising the dynamic image entry based upon the condition proximate to the first smart device and the segregated spatial areas.

2. The image generating apparatus of claim 1, wherein the executable software is additionally operative to:
a. receive via the digital communications network an identification of a second smart device; and
b. transmit to the second smart device the first interface comprising the dynamic image entry based upon the condition proximate to the first smart device.

3. The image generating apparatus of claim 2 wherein the executable software is additionally operative to:
a. receive from the first smart device via the digital communications network, an annotation to accompany the dynamic image entry; and
b. transmit to the second smart device a second user interface comprising the annotation.

4. The image generating apparatus of claim 3 wherein the annotation comprises a text message.

5. The image generating apparatus of claim 3 wherein the annotation comprises an audio message.

6. The image generating apparatus of claim 3 wherein the dynamic image data is based upon an environmental condition proximate to the first smart device.

7. The image generating apparatus of claim 6 wherein the dynamic image data is based upon an environmental condition proximate to the first smart device comprising an ambient temperature.

8. The image generating apparatus of claim 6 wherein the dynamic image data is based upon an environmental condition proximate to the first smart device comprising a presence of precipitation.

9. The image generating apparatus of claim 8 wherein the presence of precipitation comprises a rate of snow.

10. The image generating apparatus of claim 3 wherein the dynamic image data is based upon a degree of movement of the first smart device.

11. The image generating apparatus of claim 3 wherein the dynamic image data comprises an animation that is displayed upon a display of the first smart device.

12. The image generating apparatus of claim 3 wherein the dynamic image data comprises static content that is displayed that is animated on a display of the first smart device.

13. The image generating apparatus of claim 3 wherein the dynamic image data comprises dynamic sticker comprising advertising responsive to an environment of the first smart device.

14. The image generating apparatus of claim 13 wherein the dynamic image data comprises a vehicle for obtaining an item featured in the advertising and based upon the environment of the first smart device.

15. The image generating apparatus of claim 3 wherein the dynamic image data comprises a game character involved in a game being accessed by the first smart device.
